(19) United States
(12) Patent Application Publication
(10) Pub. No.: US 2008/0042570 A1
(43) Pub. Date: Feb. 21, 2008

(54) SHEET FOR PROTECTING EXTERNAL LIGHT AND PLASMA DISPLAY DEVICE THEREOF

(75) Inventors: Hong Rae Cha, Seoul (KR); Ji Hoon Sohn, Seoul (KR); Sam Je Cho, Seoul (KR); Woo Sung Jang, Seoul (KR); Woon Seo Shin, Seoul (KR); Eun Seong Seo, Seoul (KR); Joon Kwon Moon, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/839,609

(22) Filed: Aug. 16, 2007

(30) Foreign Application Priority Data
Aug. 18, 2006 (KR) 10-2006-0078266
Jul. 24, 2007 (KR) 10-2007-0074044

(51) Int. Cl. H01J 17/49; G02F 1/01

(52) U.S. Cl. 313/582; 430/6

(57) ABSTRACT

The present invention relates to an external light shielding sheet and a plasma display device thereof, and the plasma display device comprises a plasma display panel(PDP); and an external light shielding sheet, which is disposed at a front of the PDP and includes a base unit and a plurality of pattern units which are formed on the base unit and absorb external light, wherein at least one of the plurality of pattern units has an ascending portion with an average slope of 0.5 to 45 degrees and a descending portion with an average slope of −45 to −0.5 degrees.

According to the present invention, it is possible to effectively realize black images and enhance bright room contrast by arranging the external light shielding sheet, which absorbs and shields external light from the outside, at the front of the display panel(PDP). Also, it is possible to absorb external light incident upon the PDP from the top, bottom, left and right as well as not to considerably narrow the horizontal viewing angle by forming the pattern units, which absorb external light, in at least two directions.

### BACKGROUND OF THE INVENTION

1. Field of the Invention

The present invention relates to a plasma display device, and more particularly, to a plasma display device in which an external light shielding sheet is disposed at a front of a plasma display panel(PDP) in order to shield external light incident upon the PDP so that the bright room contrast of the PDP is enhanced while maintaining the luminance of the PDP.

2. Description of the Conventional Art

Generally, a plasma display panel(PDP) displays images including text and graphic images by applying a predetermined voltage to a plurality of electrodes installed in a discharge space to cause a gas discharge and then exciting phosphors with the aid of plasma generated as a result of the gas discharge. The PDP is easy to manufacture as large-dimension, light and thin flat displays. In addition, the PDP has advantages in that it can provide wide vertical and horizontal viewing angles, full colors and high luminance.

In the meantime, external light is reflected by a front surface of the PDP due to white phosphors that are exposed on a lower substrate of the PDP when the PDP displays black images. For this reason, the PDP may mistakenly recognize the black images as being brighter than they actually are, thereby causing contrast degradation.

### SUMMARY OF THE INVENTION

The present invention is derived to resolve the above problems of the prior art, and an object of the present invention is to provide a plasma display device capable of shielding external light incident upon the PDP and enhancing the bright room contrast of the PDP as well as maintaining the luminance of the PDP.

According to an aspect of the present invention, there is provided a plasma display device, including a plasma display panel(PDP); and an external light shielding sheet, which is disposed at a front of the PDP and includes a base unit and a plurality of pattern units which are formed on the base unit and absorb external light, wherein at least one of the plurality of pattern units has an ascending portion with an average slope of 0.5 to 45 degrees and a descending portion with an average slope of −45 to −0.5 degrees.

According to another aspect of the present invention, there is provided a plasma display device, including a plasma display panel; and an external light shielding sheet, which is disposed at a front of the PDP and includes a base unit and a plurality of pattern units which are formed on the base unit and absorb external light, wherein the external light shielding sheet includes first and second pattern units which are adjacently formed in parallel; and third pattern unit which is formed in crosswise manner with the first and second pattern units and connects the first and second pattern units to each other.

According to further another aspect of the present invention, there is provided a plasma display device, including a plasma display panel; and an external light shielding sheet, which is disposed at a front of the PDP and includes a base unit and a plurality of pattern units which are formed on the base unit and absorb external light, wherein the front shape of the plurality of pattern units has at least one closed curve.

According to an aspect of the present invention, there is provided an external light shielding sheet, including a base unit; and a plurality of pattern units which are formed on the base unit and absorb external light, wherein at least one of the plurality of pattern units has an ascending portion with an average slope of 0.5 to 45 degrees and a descending portion with an average slope of −45 to −0.5 degrees.

According to another aspect of the present invention, there is provided an external light shielding sheet, including a base unit; and a plurality of pattern units which are formed on the base unit and absorb external light, wherein the plurality of pattern units include first and second pattern units which are adjacently formed in parallel; and third pattern unit which is formed in crosswise manner with the first and second pattern units and connects the first and second pattern units to each other.

According to further another aspect of the present invention, there is provided an external light shielding sheet, including a base unit; and a plurality of pattern units which are formed on the base unit and absorb external light, wherein the front shape of the plurality of pattern units has at least one closed curve.

### BRIEF DESCRIPTION OF THE DRAWING

FIG. 1 is a perspective view illustrating a plasma display panel according to an embodiment of the present invention.

FIG. 2 is a cross-sectional view illustrating a structure of an external light shielding sheet provided in the filter according to an embodiment of the present invention.

FIGS. 3 to 6 are cross-sectional views illustrating optical property according to structures of the external light shielding sheet.

FIG. 7 is a cross sectional view illustrating a structure of an external light shielding sheet included in a filter according to a first embodiment of the present invention.

FIG. 8 is a view illustrating a front shape of the pattern units formed in a row in the external light shielding sheet according to an embodiment of the present invention.

FIGS. 9a to 14C are views illustrating a front shape of the external light shielding sheet according to embodiments of the present invention.

FIGS. 15 to 19 are cross sectional views illustrating shapes of the pattern units of the external light shielding sheet according to second to seventh embodiments of the present invention.

FIGS. 20 to 25 are a cross sectional view illustrating shapes of the pattern units of concave shape at the bottom of the pattern units according to the embodiments of the present invention and explaining the optical property thereof.

FIG. 26 is a cross sectional view for explaining a relation between a thickness of the external light shielding sheet and a height of the pattern units.

FIGS. 27 to 30 are cross sectional views illustrating structures of a filter having the external light shielding sheet.

### DETAILED DESCRIPTION OF THE PREFERRED EMBODIMENT

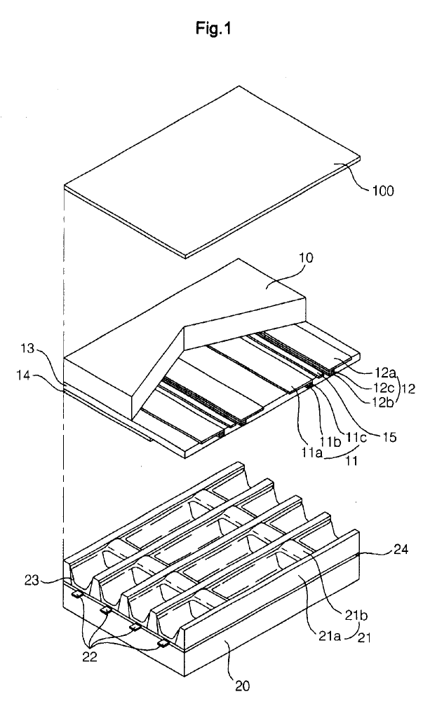

Hereinafter, the present invention will be described in detail with reference to the accompanying drawings, in which exemplary embodiments of the invention are shown. FIG. 1 is a perspective view illustrating a plasma display panel according to an embodiment of the present invention.

As shown in FIG. 1, the PDP includes a scan electrode 11 and a sustain electrode 12, which are a sustain electrode pair formed on an upper substrate 10, and an address electrode 22 formed on a lower substrate 20.

The sustain electrode pair 11 and 12 includes transparent electrodes 11a and 12a and bus electrodes 11b and 12b that are generally made of indium-tin-oxide (ITO). The bus electrodes 11b and 12b can be made of a metal such as silver (Ag) and chrome (Cr) or can be made with a stacked structure of chrome/copper/chrome (Cr/Cu/Cr) or chrome/aluminum/chrome (Cr/Al/Cr). The bus electrodes 11b and 12b are formed on the transparent electrodes 11a and 12a to reduce voltage drop due to the transparent electrodes 11a and 12a having high resistance.

Meanwhile, according to an embodiment of the present invention, the sustain electrode pair 11 and 12 can be composed of a stacked structure of the transparent electrodes 11a 12a and the bus electrodes 11b and 12b or only the bus electrodes 11b and 12b without the transparent electrodes 11a and 12a. Because the latter structure does not use the transparent electrodes 11a and 12a, there is an advantage in that a cost of manufacturing a PDP can be decreased. The bus electrodes 11b and 12b used in the structure can be made of various materials such as a photosensitive material in addition to the above-described materials.

A black matrix (BM) 15, which performs a light shielding function of reducing reflection by absorbing external light that is generated from the outside of the upper substrate 10 and a function of improving purity and contrast of the upper substrate 10 may be arranged between the transparent electrodes 11a and 12a and the bus electrodes 11b and 12b of the scan electrode 11 and the sustain electrode 12.

The black matrix 15 according to an embodiment of the present invention is formed in the upper substrate 10 and includes a first black matrix 15 that is formed in a position that is overlapped with a barrier rib 21 and second black matrixes 11 c and 12c that are formed between the transparent electrodes 11a and 12a and the bus electrodes 11b and 12b. Here, the first black matrix and the second black matrixes 11c and 12c that are also referred to as a black layer or a black electrode layer may be physically connected to each other when they are formed at the same time in a forming process or may be not physically connected to each other when they are not formed at the same time.

In addition, when they are physically connected to each other, the first black matrix 15 and the second black matrixes 11c and 12c are made of the same material, but when they are physically separated from each other, they may be made of other materials.

It is also possible for bus electrodes 11b and 12b and the barrier rib 21 to perform a light shielding function of reducing reflection by absorbing external light generated from the outside and a function of improving contrast such as the black matrixes, as the bus electrodes 11b and 12b and the barrier rib 21 are dark colored.

An upper dielectric layer 13 and a protective film 14 are stacked in the upper substrate 10 in which the scan electrode 11 and the sustain electrode 12 are formed in parallel. Charged particles, which are generated by a discharge are accumulated in the upper dielectric layer 13 and perform a function of protecting the sustain electrode pair 11 and 12. The protective film 14 protects the upper dielectric layer 13 from sputtering of charged particles that are generated at a gas discharge and enhances emission efficiency of a secondary electron.

In addition, the address electrode 22 is formed in an intersecting direction of the scan electrode 11 and the sustain electrode 12. Furthermore, a lower dielectric layer 24 and a barrier rib 21 are formed on the lower substrate 20 in which the address electrode 22 is formed.

In addition, a phosphor layer 23 is formed on the surface of the lower dielectric layer 24 and the barrier rib 21. In the barrier rib 21, a vertical barrier rib 21a and a horizontal barrier rib 21b are formed in a closed manner and the barrier rib 21 physically divides a discharge cell and prevents ultraviolet rays and visible light that are generated by a discharge from leaking to adjacent discharge cells.

Referring to FIG. 1, a filter 100 is preferably formed at the front of the PDP according to the present invention, and the filter 100 may include an external light shielding sheet, an AR (anti-reflection) sheet, a NIR (near infrared) shielding sheet and an EMI shielding sheet, a diffusion sheet and an optical sheet.

In case that a distance between the filter 100 and the PDP is 10 μm to 30 μm, it is possible to effectively shield light incident upon the PDP and to effectively emit light generated from the PDP to the outside. Also, the distance between the filter 100 and the PDP may be 30 μm to 120 μm in order to protect the PDP from the exterior pressure, and an adhesion layer, which absorbs impact, may be formed between the filter 100 and the PDP.

In an embodiment of the present invention, various shapes of barrier rib 21 structure as well as the barrier rib 21 structure shown in FIG. 1 can be used. For example, a differential barrier rib structure in which the vertical barrier rib 21a and the horizontal barrier rib 21b have different heights, a channel type barrier rib structure in which a channel, which can be used as an exhaust passage is formed in at least one of the vertical barrier rib 21a and the horizontal barrier rib 21b, and a hollow type barrier rib structure in which a hollow is formed in at least one of the vertical barrier rib 21a and the horizontal barrier rib 21b, can be used.

In the differential type barrier rib structure, it is more preferable that a height of the horizontal barrier rib 21b is higher than that of the vertical barrier rib 21a and in the channel type barrier rib structure or the hollow type barrier rib structure, it is preferable that a channel or a hollow is formed in the horizontal barrier rib 21b.

Meanwhile, in an embodiment of the present invention, it is described as each of R, G, and B discharge cells is arranged on the same line, but they may be arranged in other shapes. For example, delta type of arrangement in which the R, G, and B discharge cells are arranged in a triangle shape may be also used. Furthermore, the discharge cell may have various polygonal shapes such as a quadrilateral shape, a pentagonal shape, and a hexagonal shape.

Furthermore, the phosphor layer 23 emits light by ultraviolet rays that are generated at a gas discharge and generates any one visible light among red color R, green color G, or blue color B light. Here, inert mixed gas such as He+Xe, Ne+Xe, and He+Ne+Xe for performing a discharge is injected into a discharge space that is provided between the upper/lower substrates 10, 20 and the barrier rib 21.

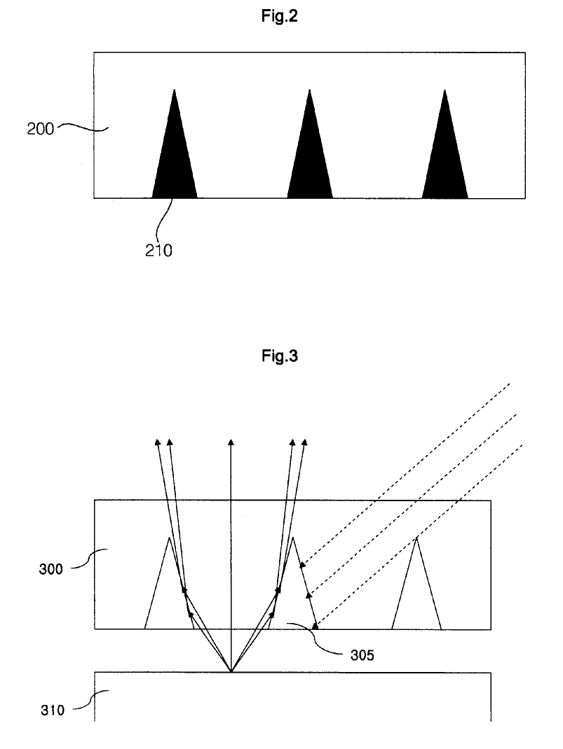

FIG. 2 is a cross-sectional view illustrating a structure of an external light shielding sheet provided in the filter according to an embodiment of the present invention, and the external light shielding sheet includes a base unit 200 and pattern units 210.

The base unit 200 is preferably formed of a transparent plastic material, for example a UV-hardened resin-based material, so that light can smoothly transmit therethrough. Alternately, it is possible to use a hard glass material to protect the front of the PDP.

Referring to FIG. 2, the pattern units 210 may be formed as various shapes as well as triangles. The pattern units 210 are formed of a darker material than the base unit 200. For example, the pattern units 210 are formed of a black carbon-based material or covered with a black dye in order to maximize the absorption of external light. Hereinafter, a wider one between top and bottom of the pattern units 210 is referred to as “bottom” of the pattern units 210.

According to FIG. 2, a bottom of the pattern units 210 may be arranged at a PDP side, and a top of the pattern units 210 may be arranged at a viewer side.

In general, an external light source is mostly located over the PDP, and thus external light is incident on the PDP from the top side at an angle and is absorbed in the pattern units 210.

In addition, the pattern units 210 may include a light-absorbing particle, and the light-absorbing particle may be a resin particle colored by a specific color. In order to maximize the light absorbing effect, the light-absorbing particle is preferably colored by a black color.

In order to maximize the absorption of external light and to facilitate the manufacture of the light-absorbing particle and the insertion into the pattern units 210, the size of the light-absorbing particle may be 1 μm or more. Also, in case that the size of the light-absorbing particle is 1 μm or more, the pattern units 210 may include the light-absorbing particle 10% weight or more in order to absorb external light more effectively. That is, the light-absorbing particle 10% weight or more of the total weight of the pattern units 210 may be included in the pattern units 210.

FIGS. 3 to 6 are cross-sectional views illustrating a structure of an external light shielding sheet according to an embodiment of the present invention in order to explain optical characteristics in accordance with the structure of the external light shielding sheet.

According to FIG. 3, a refractive index of the pattern units 305, particularly, a refractive index of at least the slanted surface of the pattern units 305 is lower than a refractive index of the base unit 300 in order to enhance the reflectivity of light from the PDP by totally reflecting visible light emitted from the PDP.

As described in the above, external light which reduces the bright room contrast of the PDP is highly likely to be above the PDP. Referring to FIG. 3, according to Snell's law, external light (illustrated as a dotted line) that is diagonally incident upon the external light shielding sheet is refracted into and absorbed by the pattern units 310 which have a lower refractive index than the base unit 300. External light refracted into the pattern units 305 may be absorbed by the light absorption particle.

Also, light (illustrated as a solid line) that is emitted from the PDP 310 for displaying is totally reflected from the slanted surface of the pattern units 305 to the outside, i.e., toward the viewer.

As described above, external light (illustrated as a dotted line) is refracted into and absorbed by the pattern units 305 and light (illustrated as a solid line) emitted from the PDP 310 is totally reflected by the pattern units 305 because an angle between the external light and the slanted surface of the pattern units 305 is greater than an angle between the light emitted from the PDP 310 and the slanted surface of the pattern units 305, as illustrated in FIG. 3.

Therefore, the external light shielding sheet according to the present invention enhances the bright room contrast of the display image by absorbing the external light to prevent the external light from being reflected toward the viewer and by increasing the reflection of light emitted from the PDP 310.

In order to maximize the absorption of external light and the total reflection of light emitted from the PDP 310 in consideration of the angle of external light incident upon the PDP 310, a refractive index of the pattern units 305 is preferably 0.3-1 times higher than a refractive index of the base unit 300. In order to maximize the total reflection of light emitted from the PDP 310 in consideration of the vertical viewing angle of the PDP, the refractive index of the pattern units 305 is preferably 0.3-0.8 times higher than the refractive index of the base unit 300.

As illustrated in FIG. 3, when a top of the pattern units 305 is arranged at the viewer side and the refractive index of the pattern units 305 is lower than the refractive index of the base unit 300, a ghost phenomenon, that is, the phenomenon that an object is not clearly seen by a viewer may be occurred because light emitted from the PDP is reflected on the slanted surface of the pattern units 305 toward the viewer side.

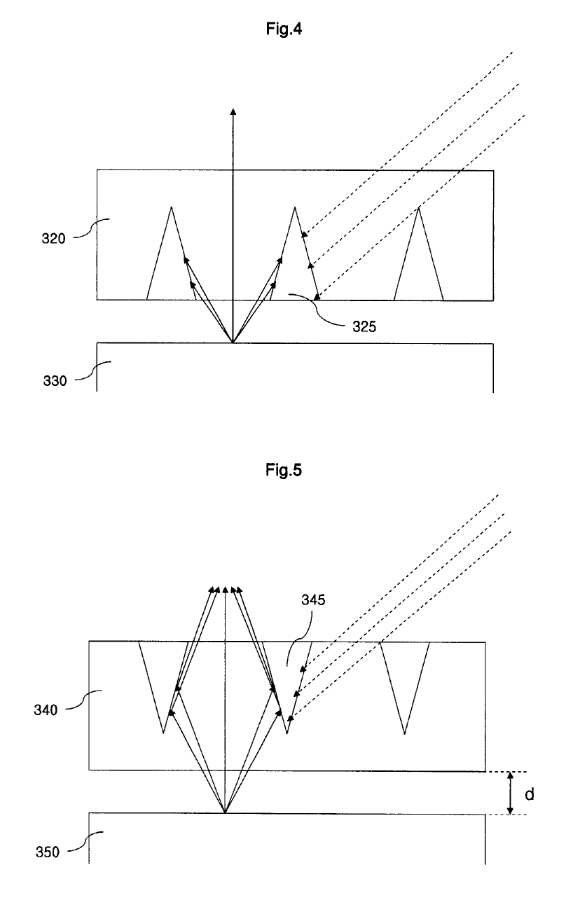

FIG. 4 illustrates the case that a top of the pattern units 325 is arranged at the viewer side and a refractive index of the pattern units 325 is higher than a refractive index of the base unit 320. Referring to FIG. 4, the refractive index of the pattern units 320 is greater than the refractive index of the base unit 320, according to Snell's law, external light that is incident upon the pattern units 325 is totally absorbed by the pattern units 325.

Therefore, the ghost phenomenon may be reduced when the top of the pattern units 325 is arranged at the viewer side and the refractive index of the pattern units 325 is higher than the refractive index of the base unit 320. A difference between the refractive index of the pattern units 325 and the refractive index of the base unit 320 is preferably 0.05 and more in order to prevent the ghost phenomenon by sufficiently absorbing light emitted from the PDP that is diagonally incident upon the pattern units 325.

When the refractive index of the pattern units 325 is higher than the refractive index of the base unit 320, light transmittance ratio of the external light shielding sheet and bright room contrast may be reduced. Therefore, the difference between the refractive index of the pattern units 325 and the refractive index of the base unit 320 is preferably 0.05 in order to prevent the ghost phenomenon and in order not to considerably reduce light transmittance ratio of the external light shielding sheet. Also, the refractive index of the pattern units 325 is preferably 1.0-1.3 times greater than the refractive index of the base unit 320 to maintain the bright room contrast as well as to prevent the ghost phenomenon.

FIG. 5 illustrates the case that a bottom of the pattern units 345 is arranged at the viewer side and a refractive index of the pattern units 345 is lower than a refractive index of the base unit 340. As illustrated in FIG. 5, the external light shielding effect can be enhanced, as external light is allowed to be absorbed in the bottom of the pattern units 345 by arranging the bottom of the pattern units 345 at the viewer side on which external light incident. Also, an opening ratio of the external light shielding sheet can be enhanced because the distance between bottoms of the pattern units 345 may be increased than the distance illustrated in the FIG. 4.

As illustrated in FIG. 5, light emitted from the PDP 350 may be reflected at the slanted surface of the pattern units 345 and be collected around light from the PDP which passes through the base unit 340. Therefore, the ghost phenomenon may be reduced without considerably lowering the light transmittance ratio of the external light shielding sheet.

It is preferable that the distance d between the PDP 350 and the external light shielding sheet is 1.5 to 3.5 mm in order to prevent the ghost phenomenon as light from the PDP is reflected from the slanted surface of the pattern units 345 and is collected around light from the PDP which passes through the base unit 340.

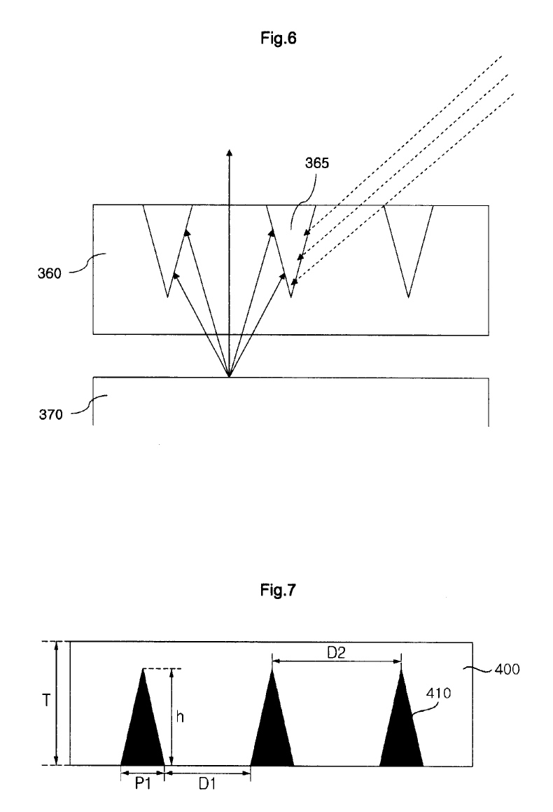

FIG. 6 illustrates the case that a bottom of the pattern units 365 is arranged at the viewer side and a refractive index of the pattern units 365 is higher than a refractive index of the base unit 360. As illustrated in FIG. 6, light from the PDP which is incident upon the slanted surface of the pattern units 365 may be absorbed in the pattern units 365 because the refractive index of the pattern units 365 is higher than the refractive index of the base unit 360. Therefore, the ghost phenomenon can be reduced, since images are displayed by light from the PDP which passes through the base unit 360.

In addition, the external light absorbing effect can be enhanced, since the refractive index of the pattern units 365 is higher than that of the base unit 360.

FIG. 7 is a cross sectional view illustrating a structure of an external light shielding sheet included in a filter according to a first embodiment of the present invention. When a thickness T of the external light shielding sheet is 20 μm to 250 μm, the manufacture of the external light shielding sheet can be facilitated and the appropriate light transmittance ratio of the external light shielding sheet can be obtained. The thickness T may be set to 100 μm to 180 μm in order to effectively absorb and shield external light refracted into the pattern units 410 and to enhance the durability of the external light shielding sheet.

Referring to FIG. 7, the pattern units 410 formed on the base unit 400 may be formed as triangles, and more preferably, as equilateral triangles. Also, a bottom width P1 of the pattern units 410 may be 18 μm to 36 μm, and in this case, it is possible to ensure an optimum opening ratio and maximize external light shielding efficiency so that light emitted from the PDP can be smooth discharged toward the user side.

The height h of the pattern units 410 is set to 80 μm to 170 μm, and thus the pattern units 410 can form a gradient capable of effectively absorbing external light and reflecting light emitted from the PDP. Also, the pattern units 410 can be prevented from being short-circuited.

In order to achieve a sufficient opening ratio to display images with optimum luminance through discharge of light emitted from the PDP toward the user side and to provide an optimum gradient for the pattern units 410 for enhancing the external light shielding efficiency and the reflection efficiency, the distance D1 between a pair of adjacent pattern units may be set to 40 μm to 90 μm, and the distance D2 between tops of the pair of adjacent pattern units may be set to 90 μm to 130 μm.

Due to the above-described reasons, an optimum opening ratio for displaying images can be obtained when the distance D1 is 1.1 to 5 times greater than the bottom width P1 of the pattern units 410. Also, in order to obtain an optimum opening ratio and to optimize the external light shielding efficiency and the reflection efficiency, the distance D1 between bottoms of the pair of adjacent pattern units 410 may be set to be 1.5 to 3.5 greater than the bottom width.

When the height h is 0.89 to 4.25 times greater than the distance D1 between the pair of adjacent pattern units, external light diagonally incident upon the external light shielding sheet from above can be prevented from being incident upon the PDP. Also, in order to prevent the pattern units 410 from being short-circuited and to optimize the reflection of light emitted from the PDP, the height h of the pattern units 410 may be set to be 1.5 to 3 times greater than the distance D1 between the pair of adjacent pattern units.

In addition, when the distance D2 between tops of a pair of adjacent pattern units is 1 to 3.25 times greater than the distance D1 between bottoms of a pair of adjacent pattern units, a sufficient opening ratio for displaying images with optimum luminance can be obtained. Also, in order to maximize the total reflection of light emitted from the PDP by the slanted surface of the pattern units 410, the distance D2 between tops of the pair of adjacent pattern units may be set to be 1.2 to 2.5 times greater than the distance D1 between bottoms of the pair of adjacent pattern units.

Although a structure of the external light shielding sheet according to the present invention is explained with the case where the top of the pattern units are arranged at the viewer side, however, it is also applicable to the case when the bottom of the pattern units 410 is arranged at the viewer side.

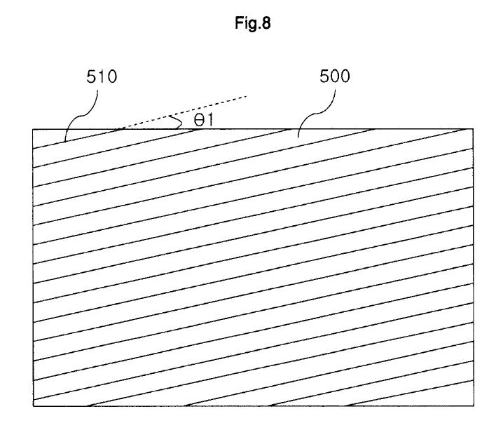

FIG. 8 is a view illustrating shape of a front surface of the pattern units formed in a row in the external light shielding sheet according to an embodiment of the present invention, and the pattern units 500 are preferably formed in a row on the base unit 510 with specific interval.

The moire phenomenon may be generated, as the PDP, for example a black matrix, a black layer, a bus electrode and a barrier rib are formed in the PDP and a plurality of pattern units 510 formed in a row on the external light shielding sheet are overlapped. The moire phenomenon is a pattern of low frequency caused by the interference between periodic images, for example there is a pattern in the shape of wave when mosquito nets are stacked.

As illustrated in FIG. 8, the moire phenomenon, which is generated as a black matrix, a black layer, a bus electrode and a barrier rib formed in the PDP are overlapped with a plurality of pattern units 510, can be reduced by diagonally forming the plurality of pattern units.

For reducing the moire phenomenon, an incident angle θ1 of a plurality of pattern units 510 is preferably 0.5 to 20 degrees. That is, the moire phenomenon may be reduced when the pattern units 510 of the external light shielding sheet are diagonally formed with an angle of 0.5 to 20 degrees. Also, in consideration that an external light source is mostly located over the head of a viewer, an appropriate opening ratio is obtained as well as the moire phenomenon is prevented and thus the reflection efficiency of light emitted from the PDP can be enhanced and external light can be effectively shielded.

In addition, due to the above-described reasons, the moire phenomenon can be reduced can be reduced when the angle between the pattern units 510 of the external light shielding sheet and the bus electrode formed in the upper substrate of the PDP or the horizontal barrier rib formed in the lower substrate of the PDP is 0.5° to 20°. Also, in consideration that an external light source is mostly located over the head of a viewer, an appropriate opening ratio is obtained as well as the moire phenomenon is prevented and thus the reflection efficiency of light emitted from the PDP can be enhanced and external light can be effectively shielded.

According to FIG. 8, the pattern units 510 are diagonally formed from the right-bottom to the left-top of the external light shielding sheet, however the pattern units 510 may be diagonally formed from the left-top to the right-bottom of the external light shielding sheet at the same angle according to another embodiment of the present invention.

The pattern units of the external light shielding sheet according to the present invention are preferably formed in at least 2 directions in order to absorb light that is incident from the top-bottom of the PDP as well as the left-right of the PDP. The bright room contrast of display images can be further enhanced as external light that is incident from left or right is absorbed in the pattern units of the external light shielding sheet.

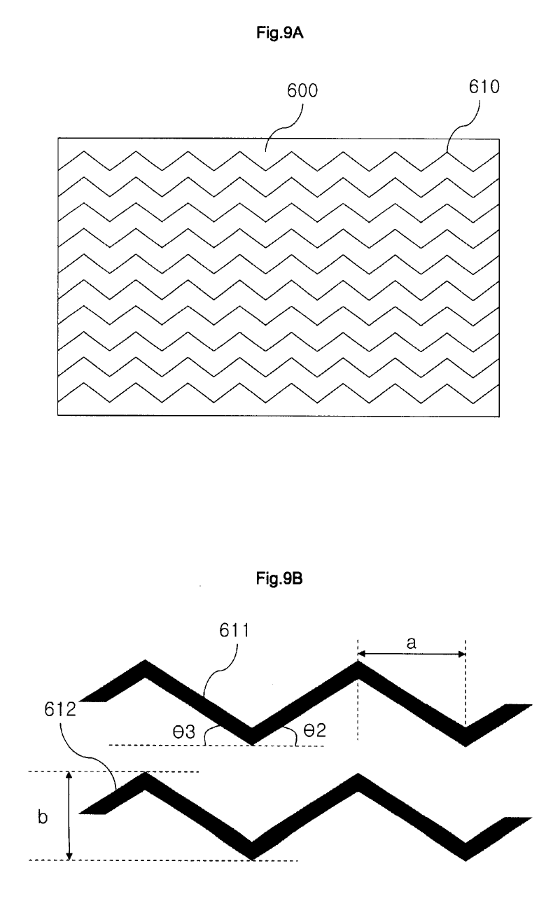

FIGS. 9A to 14C are views illustrating shapes of a front surface of the pattern units of the external light shielding sheet according to the present invention, the external light shielding sheet according to the present invention may have various structures, in which a plurality of pattern units are formed in at least 2 directions to absorb external light that is incident from at least 3 directions, as well as the shapes of the front surface illustrated in FIGS. 9A to 14C.

Referring to FIG. 9A, the pattern units 610 formed on the base unit 600 may include a portion with an ascending gradient and a portion with a descending gradient, and thus, it is possible to absorb external light that is incident upon the PDP from top, bottom, right and left sides of the PDP.

Referring to FIG. 9B, the angle θ2 in the ascending portion of the pattern units 611 is preferably 0.5 to 45 degrees in consideration that external light is mostly incident upon the PDP from the top of the PDP so as to effectively absorb external light that is incident upon the PDP. Also, the angle θ3 in the descending portion of the pattern units 611 is preferably −0.5 to −45 degrees.

The horizontal viewing angle is reduced when the angle of the pattern units 611 is too high. The angle θ2 in the ascending portion of the pattern units 611 may be 0.5 to 20 degrees and the angle θ3 in the descending portion of the pattern units 611 may be −0.5 to −20 degrees in order to obtain sufficient horizontal viewing angle and to absorb external light incident upon the PDP from top, bottom, right and left sides of the PDP and to prevent the luminance from being reduced.

Therefore, the external light absorbing efficiency, the horizontal viewing angle and the luminance can be enhanced when a vertical distance b between the highest point and the lowest point is 0.36 or less times greater than a horizontal distance a between the highest point and the lowest point of the pattern units.

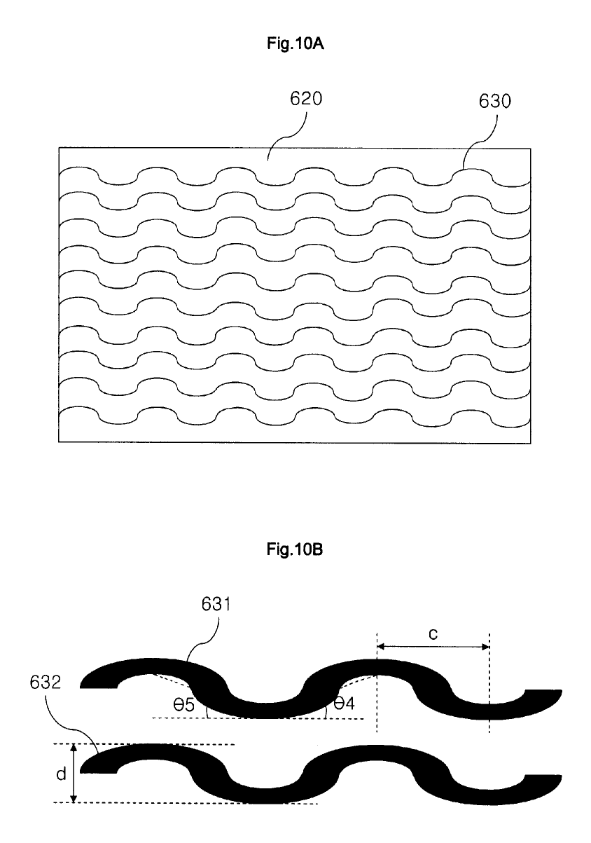

Referring to FIG. 10A, the front of the pattern units 630 may have a curved shape to reduce the moire phenomenon generated with straight electrodes and barrier ribs that are formed in the PDP in the vertical and horizontal directions and to produce the pattern units 630 with ease.

Referring to FIG. 10B, The angle 04 in the ascending portion of the pattern units 631 is preferably 0.5 to 45 degrees and the angle θ5 in the descending portion of the pattern units 631 is preferably −0.5 to −45 degrees in order to absorb external light incident upon the PDP mostly from top and rarely from right and left sides of the PDP.

The angle θ4 in the ascending portion of the pattern units 631 may be 0.5 to 20 degrees and the angle θ5 in the descending portion of the pattern units 631 may be −0.5 to −20 degrees in order to obtain sufficient horizontal viewing angle and to absorb external light incident upon the PDP from top, bottom, right and left sides of the PDP and to prevent the luminance from being reduced.

Therefore, the vertical distance b between the highest point and the lowest point is 0.36 or less times greater than the horizontal distance a between the highest point and the lowest point of the pattern units in order to improve the external light absorbing efficiency, the horizontal viewing angle and the luminance at the same time.

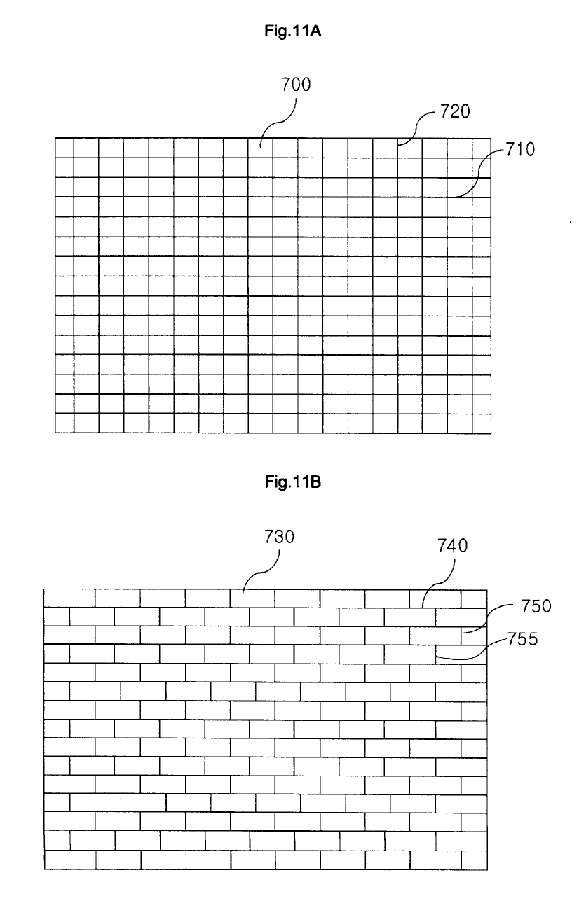

Referring to FIG. 11A, a first pattern unit 710 formed in the base unit 700 of the external light shielding sheet in the horizontal direction, i.e. from the left to the right of the PDP, and a second pattern unit 720 formed in the vertical direction in a crosswise manner with the first pattern unit 710 may be included. Therefore, the first pattern unit 710 formed in the horizontal direction absorbs external light incident upon the PDP from the top and bottom of the PDP and the second pattern unit 720 formed in the vertical direction absorbs external light incident upon the PDP from the left and right of the PDP. The pattern units 710, 720 absorb external light incident upon the PDP from the top, bottom, left and right of the PDP, and thus, the bright room contrast of display images can be enhanced.

Also, as illustrated in FIG. 11B, the moire phenomenon, which is generated with another structures having specific pattern for example a mesh pattern of the electromagnetic interference (EMI) layer, an electrode, a barrier rib and a black matrix in the PDP, can be reduced by arranging the vertical pattern units 750, 755 in a crosswise manner.

Referring to FIG. 11B, the pattern units 740, 750, 755 formed in the base unit 730 may include the pattern units 710 formed in the horizontal direction and the pattern units 750, 755 formed in the vertical direction. Also, the vertical pattern units 750, 755 may connect adjacent two horizontal pattern units together.

As illustrated in FIGS. 11A and 11B, the pattern units of the external light shielding sheet can absorb all external light incident upon the PDP from the top, bottom, left and right of the PDP as the front shape of the pattern units has at least one closed curve.

Referring to FIG. 11C, a width f of the vertical pattern units 751 is preferably 0.1 to 5 times greater than a width e of the horizontal pattern units 741 so that external light incident upon the PDP from the top, bottom, left and right of the PDP is absorbed and the opening ratio is sufficiently obtained and thus the decrement of the luminance is reduced and the width of the pattern units 751, 752, 753 is adjusted for facilitating the manufacture.

The width f of the vertical pattern units 751 is preferably smaller than the width e of the horizontal pattern units 741 in consideration that the viewer feels uncomfortable when the horizontal viewing angle is lower than the vertical viewing angle. Therefore, it is possible to improve the external light absorbing efficiency and the luminance of images as well as to obtain sufficient horizontal viewing angle by forming the width f of the vertical pattern units 751 is 0.3 to 0.6 times greater than the width e of the horizontal pattern units 741.

Also, in order to prevent the horizontal viewing angle from being narrowed, the distance g between two horizontal pattern units 741, 742 is preferably smaller than the distance h between two vertical pattern units 751, 752.

Therefore, in order to improve the external light absorbing efficiency and the luminance of images as well as to obtain sufficient horizontal viewing angle, the distance g between two horizontal pattern units 741, 742 may be 0.05 to 0.5 times greater than the distance h between two vertical pattern units 751, 752.

Accordingly, the distance g between two adjacent horizontal pattern units 741, 742 is preferably 40 μm to 90 μm as described in the above, and thus, the distance h between two adjacent horizontal pattern units 751, 752 is preferably 40 μm to 90 μm and the width f of the vertical pattern units 751 is preferably 0.3 times greater than the width e of the horizontal pattern units 741.

As described in the above, the moire phenomenon can be occurred by overlapping the regions having the same pattern, and thus, the moire phenomenon can be occurred between the vertical pattern units 751, 752, 753, and electrodes and barrier ribs vertically formed with a specific interval in the PDP.

Referring to FIG. 11C, the moire phenomenon may be reduced by not making specific pattern with the electrodes and barrier ribs formed in the PDP with a specific interval as differentiating the distances h, I between adjacent, two vertical pattern units.

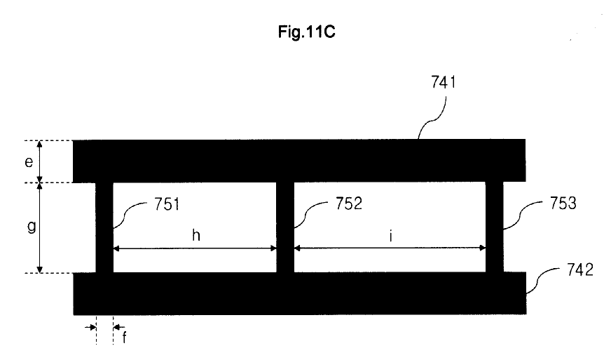

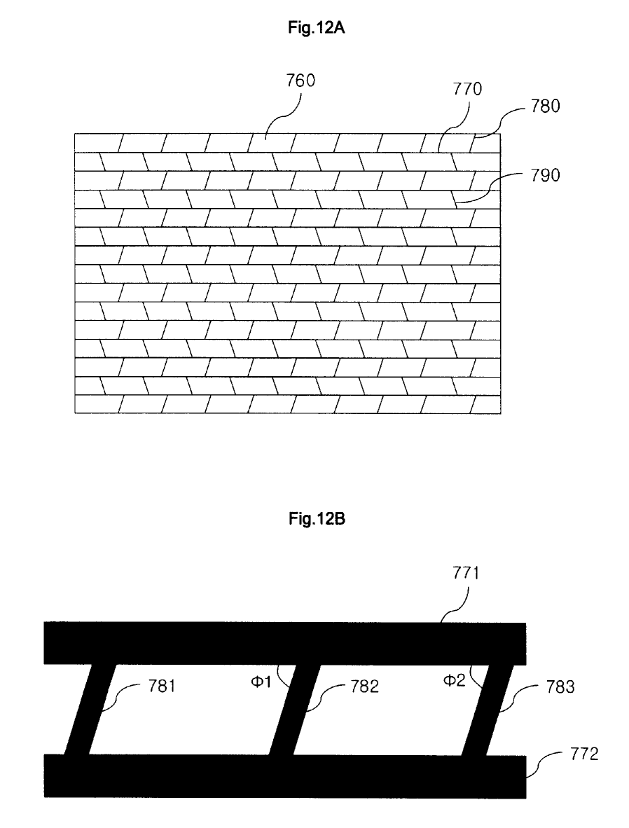

Also, the moire phenomenon which is occurred with the electrodes and barrier ribs vertically formed in the PDP may be reduced by diagonally forming the vertical pattern units 780, 790 at a specific angle, as illustrated in FIG. 12A.

Referring to FIG. 12B, in order to improve the external light absorbing efficiency and the horizontal viewing angle as well as to reduce the moire phenomenon, the angle θ1 between the horizontal pattern units 771 and the vertical pattern units 782 is preferably 45 to 135 degrees. Also, the angle θ1 between the horizontal pattern units 771 and the vertical pattern units 782, and the angle θ2 between the horizontal pattern units 771 and the vertical pattern units 783 may different to each other.

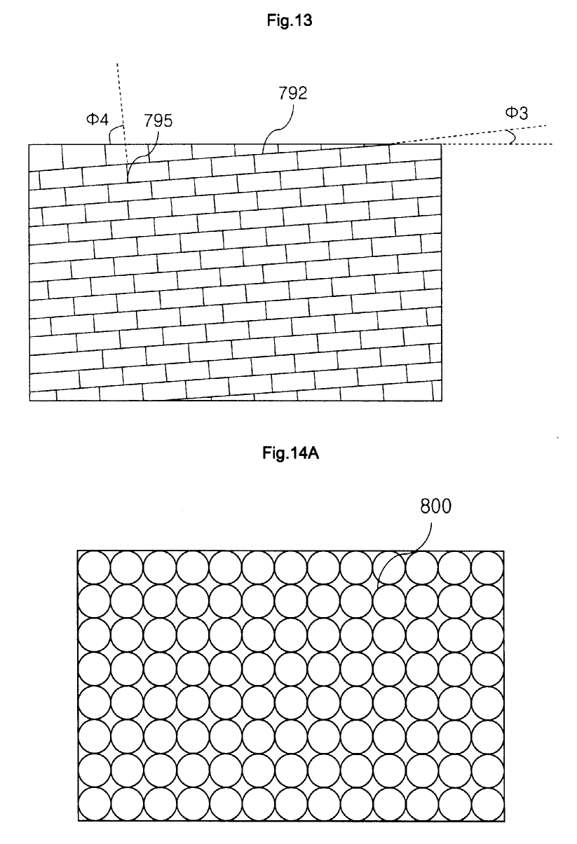

Also, as illustrated in FIG. 13, the moire phenomenon which is occurred with the electrodes and barrier ribs in the PDP may be reduced by diagonally forming the horizontal pattern units 792 and the vertical pattern units 795 at the angles θ3, ♭4, respectively. As described in the above, the angle θ3 of the horizontal pattern units 792 may be 0.5 to 20 degrees, and the angle θ4 of the vertical pattern units 795 may be 45 to 135 degrees.

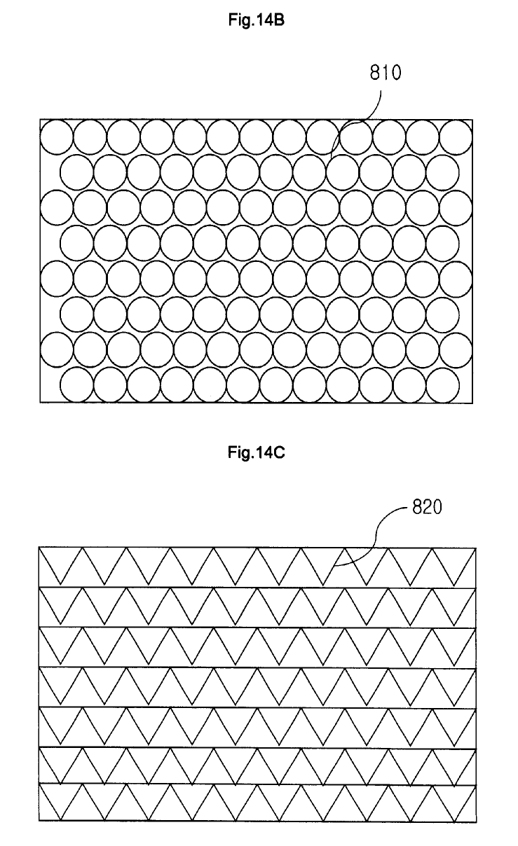

FIGS. 14A to 14C illustrate structures of the external light shielding sheet in which the front shape of a plurality of pattern units has at least one closed curve according to another embodiment of the present invention. And, the front shape of the plurality of pattern units 800, 810, 820 may have at least one polygon or circle. Therefore, the plurality of pattern units 800, 810, 820 may absorb external light incident upon the PDP from 3 directions.

Also, the front shape of the pattern units of the external light shielding sheet may have various shapes having at least one closed curve other than the shape illustrated in FIGS. 14A to 14C.

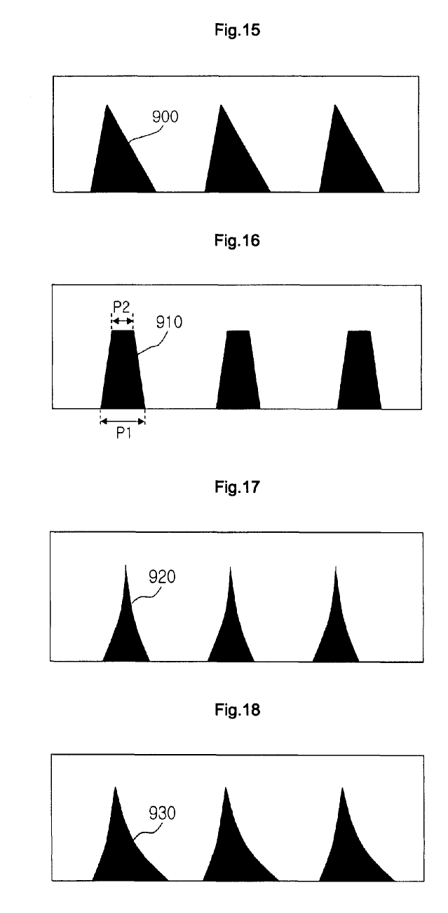

FIGS. 15 to 19 are cross sectional views illustrating the shape of the pattern units of the external light shielding sheet according to the embodiments of the present invention.

Referring to FIG. 15, the pattern units 900 may be horizontally asymmetrical. That is, left and right slanted surfaces of the pattern units 900 may have different areas or may form different angles with the bottom. In general, an external light source is located above the PDP, and thus external light is highly likely to be incident upon the PDP from above within a predetermined angle range. Therefore, in order to enhance the absorption of external light and the reflection of light emitted from the PDP, one of two slanted surfaces of the pattern units 900 may be less steep than the other of the pattern units 900.

Referring to FIG. 16, the pattern units 910 may be trapezoidal, and in this case, the top width P2 of the pattern units is less than the bottom width P1 of the pattern unit. Also, the top width P2 of the pattern units 910 may be 10 μm or less, and therefore the slope of the slanted surfaces can be determined according to the relationship between the bottom width P1 so that the absorption of external light and the reflection of light emitted from the PDP can be optimized.

As illustrated in FIGS. 17 to 19, the pattern units 920, 930, 940 may have a curved shape having a predetermined curvature at the left and right slanted surfaces. In this case, the slope angle of the slanted surface of the pattern units 920, 930, 940 is preferably getting gentle in a direction to the top from the bottom.

In addition, according to the embodiments of the pattern units illustrated in FIGS. 17 to 19, the pattern units may have curved edges having a predetermined curvature.

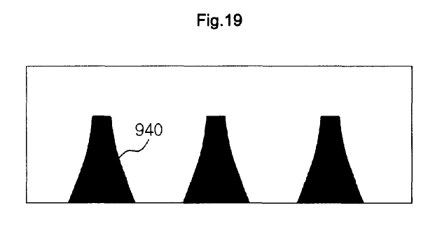

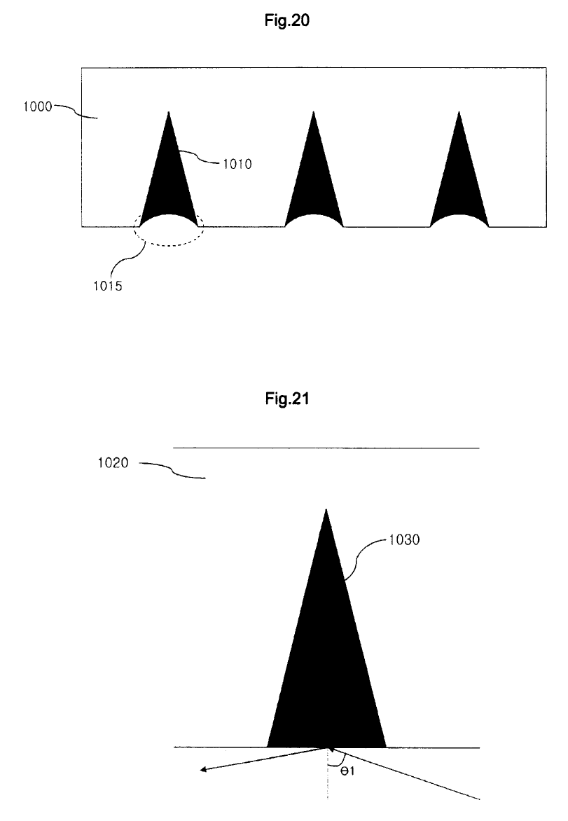

FIG. 20 is a cross sectional view illustrating the shape of the pattern units of concave shape at the bottom of the pattern units according to the embodiments of the present invention.

As illustrated in FIG. 20, bleeding phenomenon of the image that is generated as light emitted from the PDP is reflected on the bottom 1015 of the pattern units can be reduced by forming a center of the bottom 1015 of the pattern units as a round hole or a concave. Also, when the external light shielding sheet is attached to another functional sheet or the PDP, adhesive force can be enhanced as the area of the contact portion is increased.

That is, the pattern units 1010 having a concave bottom 1015 may be formed by forming the pattern units 1010 in which the height of the center area is lower than the height of the outer most contour.

The pattern units 1010 may be formed by filling light-absorbing materials into the recess formed in the base unit 1000, wherein some of the recesses formed in the base unit 1000 may be filled by the light-absorbing materials and the rest of the recesses may be left as an occupied space. Therefore, the bottom 1015 of the pattern units 1010 may be a concave shape in which the center area is depressed into the inside.

As illustrated in FIG. 21, light that is emitted from the PDP and diagonally incident upon the bottom of the pattern units 1030 may be reflected toward the PDP, when the bottom of the pattern units 1030 is flat. As images, to be displayed at a specific position by light reflected toward the PDP, are displayed around the specific position, and thus, the sharpness of the display images may be reduced because the bleeding phenomenon is occurred.

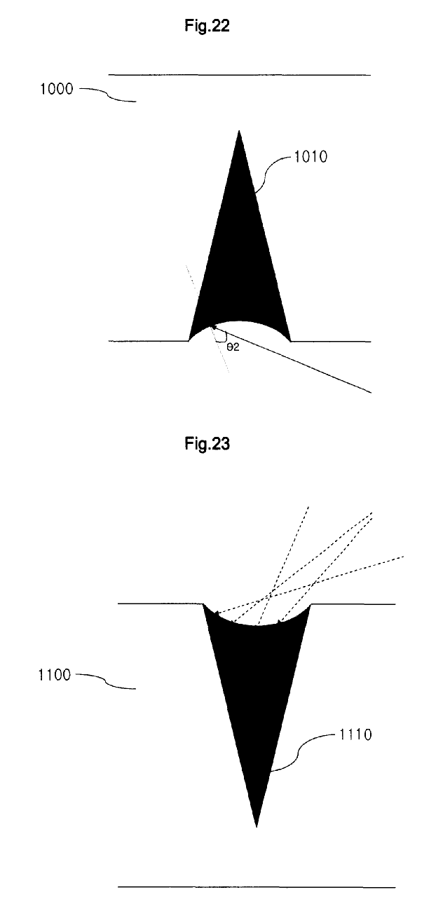

Referring to FIG. 22, an incident angle θ2 that is diagonally incident upon the bottom of the pattern units 1010 having a depressed shape is smaller than the incident angle θ1 that is incident upon the bottom of the pattern units 1030 having a flat shape illustrated in FIG. 21. Therefore, the PDP light that is reflected on the bottom of the pattern units 1030 having a flat shape may be absorbed into the pattern units 1010 at the bottom of the pattern units 1010 having a depressed shape. Therefore, the sharpness of the display images may be enhanced by reducing the bleeding phenomenon of the display images.

FIG. 23 is a cross sectional view illustrating a structure of the external light shielding sheet with the pattern units having a concave shape at the bottom, which is arranged at a viewer side.

Referring to FIG. 23, the incident angle of external light that is absorbed in the bottom of the pattern units 1110 can be increased by forming the bottom of the pattern units 1110 as a concave. That is, when the bottom of the pattern units 1110 is formed as a concave, the incident angle of external light that is incident upon the bottom of the pattern units 1110 may be increased, and thus, the absorption of external light can be increased.

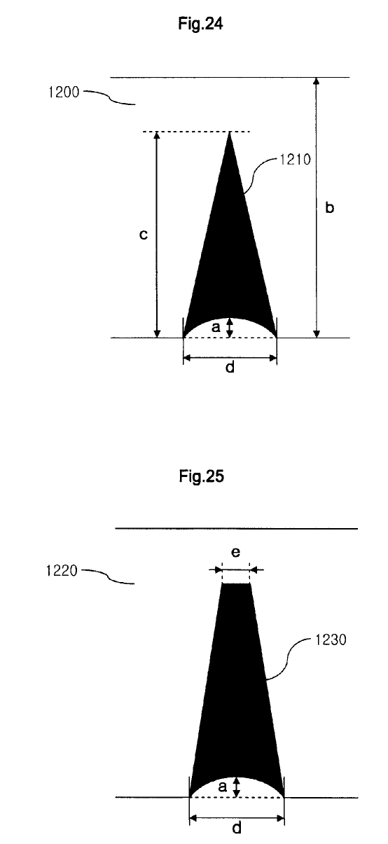

FIG. 24 is a cross sectional view illustrating the shape of the pattern units having a concave shape at the bottom according to the embodiment of the present invention. Table 1 presents experimental results about the bleeding phenomenon of the display images according to the depth a of the recess of the width d of the pattern units 1210, that is, Table 1 presents experimental results about whether the bleeding phenomenon of images is reduced or not compared with the PDP in which the external light shielding panel having flat pattern units is arranged.

TABLE 1

| Depth (a) of | Bottom width (d) of | Reduction of bleeding |
|---|---|---|
| recess | pattern unit | phenomenon |
| 0.5 μm | 27 μm | x |
| 1.0 μm | 27 μm | x |
| 1.5 μm | 27 μm | ∘ |
| 2.0 μm | 27 μm | ∘ |
| 2.5 μm | 27 μm | ∘ |
| 3.0 μm | 27 μm | ∘ |
| 3.5 μm | 27 μm | ∘ |
| 4.0 μm | 27 μm | ∘ |
| 4.5 μm | 27 μm | ∘ |
| 5.0 μm | 27 μm | ∘ |
| 5.5 μm | 27 μm | ∘ |
| 6.0 μm | 27 μm | ∘ |
| 6.5 μm | 27 μm | ∘ |
| 7.0 μm | 27 μm | ∘ |
| 7.5 μm | 27 μm | x |
| 8.0 μm | 27 μm | x |
| 9.0 μm | 27 μm | x |
| 9.5 μm | 27 μm | x |

As described in Table 1, the sharpness of the display images may be enhanced by reducing the bleeding phenomenon of the display images, when a depth a of the depressed recess formed in the bottom of the pattern units 1210 is 1.5 μm to 7.0 μm.

Also, the depth a formed in the bottom of the pattern units 1210 is preferably 2 μm to 5 μm in consideration of the protection of the pattern units 1210 from the exterior pressure, and the manufacturing facilitation of the pattern units 1210.

As described in the above with reference to FIG. 7, it is possible to ensure an optimum opening ratio and maximize external light shielding efficiency, when a bottom width d of the pattern units 1210 is 18 μm to 35 μm, and thus, the bottom width d of the pattern units 1210 is preferably set to be 3.6 to 17.5 times greater than a depth a of a recess formed on the bottom of the pattern units 1210.

Meanwhile, it is possible to form a gradient of the slanted surface capable of optimizing the absorption of external light and the reflection of light emitted from the PDP, when a height c of the pattern units 1210 is 80 μm to 170 μm, and thus, the height c of the pattern units 1210 is preferably set to be 16 to 85 times greater than the depth a of the recess formed on the bottom of the pattern units 1210 between the pair of adjacent pattern units.

Also, the thickness b of the external light shielding sheet is preferably set to be 20 to 90 times greater than the depth a of the recess formed in the bottom of the pattern units 1210, because it is possible to obtain the appropriate transmittance of light emitted from the PDP, the absorption and the shielding as well as the durability of the external light shielding sheet when the thickness b of the external light shielding sheet is 100 μm to 180 μm.

Referring to FIG. 25, the pattern units 1230 may be trapezoidal, and in this case, the top width e of the pattern units is preferably less than the bottom width d of the pattern units. Also, when the top width e of the pattern units 1230 may be 10 μm or less, and the slope of the slanted surfaces can be determined according to the relationship between the bottom width d so that the absorption of external light and the reflection of light emitted from the PDP can be optimized. In this case, relationship between the top width e of the pattern units 1230 and the bottom width d of the pattern units 1230 may be the same as illustrated in FIG. 24.

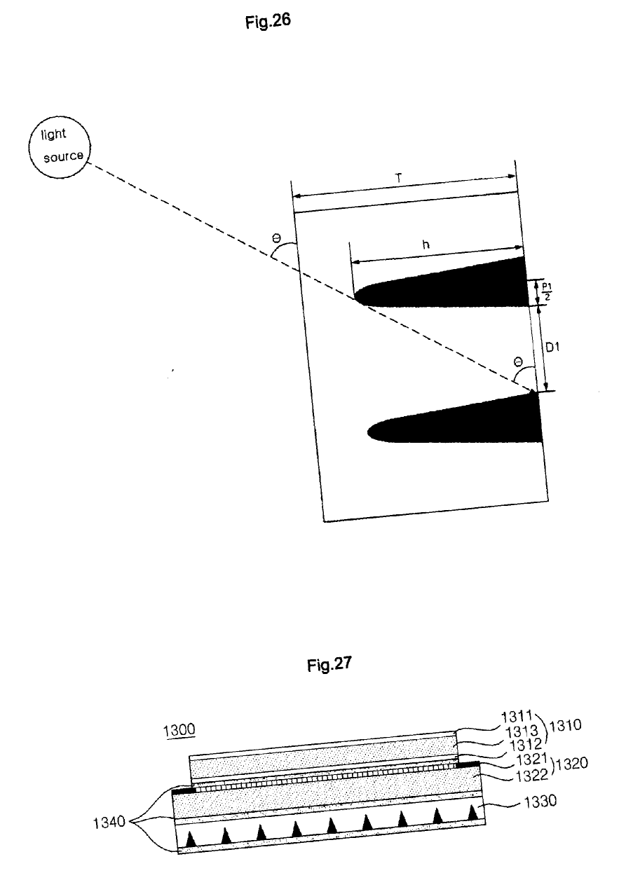

FIG. 26 is a cross sectional view illustrating a structure of the external light shielding sheet to explain the relation between the thickness of the external light shielding sheet and the height of the pattern units.

Referring to FIG. 26, the thickness T of the external light shielding sheet is preferably set to 100 μm to 180 μm in order to obtain appropriate transmittance ratio of visible light emitted from the PDP for displaying images as well as to enhance the durability of the external light shielding sheet including the pattern units.

When the height h provided in the external light shielding sheet is 80 μm to 170 μm, the manufacture of the external light shielding sheet can be facilitated, the appropriate opening ratio of the external light shielding sheet can be obtained, and the function of shielding external light and the function of reflecting light emitted from the PDP can be maximized.

The height h of the pattern units can be varied according to the thickness T of the external light shielding sheet. In general, external light that considerably affects the bright room contrast of the PDP is highly likely to be incident upon the PDP from the above. Therefore, in order to effectively shield external light with an angle within a predetermined range, the height h of the pattern units is preferably within a predetermined percentage of the thickness T of the external light shielding sheet.

As the height h of the pattern units increases, the thickness of the base unit, which is top region of the pattern units, decreases, and thus, dielectric breakdown may occur. On the other hand, as the height h of the pattern units decreases, more external light is likely to be incident upon the PDP at various angles within a predetermined range, and thus the external light shielding sheet may not properly shield the external light.

Table 2 presents experimental results about the dielectric breakdown and the external light shielding effect of the external light shielding sheet according to the thickness T of the external light shielding sheet and the height h of the pattern units.

TABLE 2

| Thickness (T) of | | | |
|---|---|---|---|
| external light | Height (h) of | Dielectric | External light |
| shielding sheet | pattern units | breakdown | shielding |
| 120 μm | 120 μm | ∘ | ∘ |
| 120 μm | 115 μm | Δ | ∘ |
| 120 μm | 110 μm | x | ∘ |
| 120 μm | 105 μm | x | ∘ |
| 120 μm | 100 μm | x | ∘ |
| 120 μm | 95 μm | x | ∘ |
| 120 μm | 90 μm | x | ∘ |
| 120 μm | 85 μm | x | Δ |
| 120 μm | 80 μm | x | Δ |
| 120 μm | 75 μm | x | Δ |
| 120 μm | 70 μm | x | Δ |
| 120 μm | 65 μm | x | Δ |
| 120 μm | 60 μm | x | Δ |
| 120 μm | 55 μm | x | Δ |
| 120 μm | 50 μm | x | x |

Referring to Table 2, when the thickness T of the external light shielding sheet is 120 μm or more, and the height h of the pattern units 115 μm or more, the pattern units are highly likely to dielectric breakdown, thereby increasing defect rates of the product. When the height h of the pattern units 115 μm or less, the pattern units are less likely to dielectric breakdown, thereby reducing defect rates of the external light shielding sheet. However, when the height h of the pattern units is 85 μm or less, the shielding efficiency of external light may be reduced, and when the height h of the pattern units is 60 μm or less, external light is likely to be directly incident upon the PDP. Therefore, when the height h of the pattern units is 90 μm to 110 μm, the shielding efficiency of the external light shielding sheet may be increased as well as the defect rates of the external light shielding sheet may be decreased. In addition, when the thickness T of the external light shielding sheet is 1.01 to 2.25 times greater than the height h of the pattern units, it is possible to prevent the top portion of the pattern units from dielectrically breaking down and to prevent external light from being incident upon the PDP. Also, in order to prevent dielectric breakdown and infiltration of external light into the PDP, to increase the reflection of light emitted from the PDP, and to secure optimum viewing angles, the thickness T the external light shielding sheet may be 1.01 to 1.5 times greater than the height h of the pattern units.

Table 3 presents experimental results about the occurrence of the moire phenomenon and the external light shielding effect of the external light shielding sheet according to different pattern unit bottom width P1-to-bus electrode width ratios, when the width of the bus electrode is 70 μm.

TABLE 3

| Bottom width of | | |
|---|---|---|
| pattern units/Width | | External light |
| of bus electrodes | Moire | shielding |
| 0.10 | Δ | x |
| 0.15 | Δ | x |
| 0.20 | x | Δ |
| 0.25 | x | ∘ |
| 0.30 | x | ∘ |
| 0.35 | x | ∘ |
| 0.40 | x | ∘ |
| 0.45 | Δ | ∘ |
| 0.50 | Δ | ∘ |
| 0.55 | ∘ | ∘ |
| 0.60 | ∘ | ∘ |

Referring to Table 3, when the bottom width of the pattern units is 0.2 to 0.5 times greater than the bus electrode width, the moire phenomenon can be reduced as well as external light incident upon the PDP can be reduced. Also, in order to prevent the moire phenomenon, to effectively shield external light, and to secure a sufficient opening ratio for discharging light emitted from the PDP, the bottom width of the pattern units is preferably 0.25 to 0.4 times greater than the bus electrode width.

Table 4 presents experimental results about the occurrence of the moire phenomenon and the external light shielding effect according to different pattern unit bottom width of the external light shielding sheet-to-vertical barrier rib width ratios, when the width of the vertical barrier rib is 50 μm.

TABLE 4

| Bottom widths of | | |
|---|---|---|
| pattern units/Top width | | External light |
| of vertical barrier ribs | Moire | shielding |
| 0.10 | ∘ | x |
| 0.15 | Δ | x |
| 0.20 | Δ | x |
| 0.25 | Δ | x |
| 0.30 | x | Δ |
| 0.35 | x | Δ |
| 0.40 | x | ∘ |
| 0.45 | x | ∘ |
| 0.50 | x | ∘ |
| 0.55 | x | ∘ |
| 0.60 | x | ∘ |
| 0.65 | x | ∘ |
| 0.70 | Δ | ∘ |
| 0.75 | Δ | ∘ |
| 0.80 | Δ | ∘ |
| 0.85 | ∘ | ∘ |
| 0.90 | ∘ | ∘ |

Referring to Table 4, when the bottom width of the pattern units is 0.3 to 0.8 times greater than the top width of the vertical barrier rib, the moire phenomenon can be reduced as well as external light incident upon the PDP can be reduced. Also, in order to prevent the moire phenomenon, to effectively shield external light, and to secure a sufficient opening ratio for discharging light emitted from the PDP, the bottom width of the pattern units is preferably 0.4 to 0.65 times greater than the top width of the vertical barrier rib.

FIGS. 27 to 30 are cross-sectional views illustrating a structure of a filter according to embodiments of the present invention. The filter formed at a front of the PDP may include an anti-reflection (AR)/near infrared (NIR) sheet, an electromagnetic interference (EMI) sheet, an external light shielding sheet and an optical sheet.

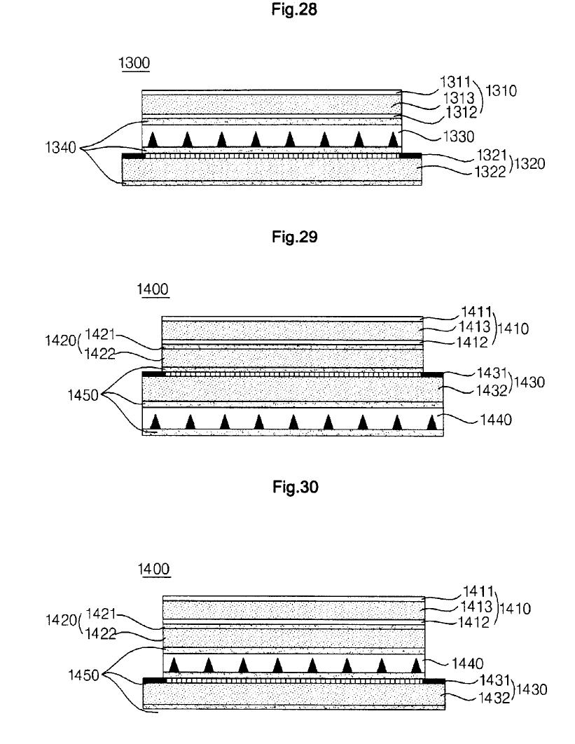

Referring to FIGS. 27 and 28, an anti-reflection (AR) layer 1311 which is attached onto a front surface of the base sheet 1313 and reduces glare by preventing the reflection of external light from the outside is attached onto the AR/NIR sheet 1310, and a near infrared (NIR) shielding layer 1312 which shields NIR rays emitted from the PDP so that signals provided by a device such as a remote control which transmits signals using infrared rays can be normally transmitted is attached onto a rear surface of the AR/NIR sheet.

The electromagnetic interference (EMI) sheet 1320 includes an electromagnetic interference (EMI) layer 1321 which is attached onto a front surface of the base sheet 1322 which is formed of a transparent plastic material and shields EMI emitted from the PDP so that the EMI can be prevented from being released to the outside. Here, the electromagnetic interference (EMI) layer 1321 is generally formed of a conductive material in a mesh form. An invalid display area of the electromagnetic interference (EMI) sheet 1320 where no image is displayed is covered with a conductive material in order to properly ground the electromagnetic interference (EMI) layer.

In general, an external light source is mostly located over the head of a viewer regardless of an indoor or outdoor environment. The external light shielding sheet 1330 is attached thereto so that external light is effectively shielded and thus black images of the PDP can be rendered even blacker.

An adhesive layer 1340 is interposed between the AR/NIR sheet 1310, the electromagnetic interference (EMI) sheet 1320 and the external light shielding sheet 1330, so that the sheets 1310, 1320, 1330 and the filter 1300 can be firmly attached onto the front surface of the PDP. Also, the base sheets interposed between the sheets 1310, 1320,1330 are preferably made of the same material in order to facilitate the manufacture of the filter 1300.

Meanwhile, according to FIG. 27, the AR/NIR sheet 1310, the electromagnetic interference (EMI) sheet 1320, and the external light shielding sheet 1330 are sequentially stacked. Alternatively, the AR/NIR sheet 1310, the external light shielding sheet 1330 and the electromagnetic interference (EMI) sheet 1320 may be sequentially stacked, as illustrated in FIG. 28. The order in which the AR/NIR sheet 1310, the electromagnetic interference (EMI) sheet 1320 and the external light shielding sheet 1330 are stacked is not restricted to those set forth herein. Also, at least one layer of the illustrated sheets 1310, 1320, 1330 can be omitted.

Referring to FIGS. 29 and 30, a filter 1400 disposed at the front surface of the PDP may further include an optical sheet 1420 as well as an AR/NIR sheet 1410, an electromagnetic interference (EMI) sheet 1430 and an external light shielding sheet 1440. The optical sheet 1420 enhances the color temperature and luminance properties of light from the PDP, and an optical sheet layer 1421 which is formed of a dye and an adhesive is stacked on a front or rear surface of the base sheet 1422 which is formed of a transparent plastic material.

At least one of the base sheets illustrated in FIGS. 27 to 30 may be abbreviated, and at least one of the base sheets may be formed of a hard glass instead of being formed of a plastic material, so that the protection of the PDP can be enhanced. It is preferable that the glass is formed at a predetermined spacing apart from the PDP.

In addition, the filter according to the present invention may further include a diffusion sheet. The diffusion sheet serves to diffuse light incident upon the PDP to maintain the uniform brightness. Therefore, the diffusion sheet may widen the vertical viewing angle and conceal the patterns formed on the external light shielding sheet by uniformly diffusing light emitted from the PDP. Also, the diffusion sheet may enhance the front luminance as well as antistatic property by concentrating light in the direction corresponding to the vertical viewing angle.

As a diffusion sheet, a transmissive diffusion film or a reflective diffusion film can be used. The diffusion sheet may have the mixed form that small glass particles are mixed in the base sheet of polymer material. Also, PMMA may be used as a base sheet of the diffusion film. When PMMA is used as a base sheet of the diffusion film, it can be used in large display devices because thermal resistance of the base sheet is good enough despite of it's thick thickness.

According to the present invention, it is possible to effectively realize black images and enhance bright room contrast by arranging the external light shielding sheet, which absorbs and shields external light from the outside, at the front of the display panel. Also, it is possible to absorb external light incident upon the PDP from the top, bottom, left and right as well as not to considerably narrow the horizontal viewing angle by forming the pattern units, which absorb external light, in at least two directions.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is;

1. A plasma display device, comprising:
a plasma display panel(PDP); and
an external light shielding sheet, which is disposed at a front of the PDP and includes a base unit and a plurality of pattern units which are formed on the base unit and absorb external light, wherein at least one of the plurality of pattern units has an ascending portion with an average slope of 0.5 to 45 degrees and a descending portion with an average slope of −45 to −0.5 degrees.

2. The plasma display device of claim 1, wherein the average slope of the ascending portion is 0.5 to 20 degrees.

3. The plasma display device of claim 1, wherein the average slope of the descending portion is −20 to −0.5 degrees.

4. The plasma display device of claim 1, wherein a slope of at least one of the ascending portions and descending portions is gradually increased or decreased.

5. The plasma display device of claim 1, wherein a vertical distance between the highest point and the lowest point of the pattern units is 0.36 or less times greater than a horizontal distance between the highest point and the lowest point of the pattern units.

6. The plasma display device of claim 1, wherein a refractive index of the pattern units is higher than a refractive index of the base unit, and a difference between a refractive index of the pattern units and a refractive index of the base unit is 0.05 to 0.3.

7. The plasma display device of claim 1, wherein a refractive index of the pattern units is 1.0 to 1.3 times greater than a refractive index of the base unit.

8. The plasma display device of claim 1, wherein bottoms of the pattern units are wider than tops of the pattern units and the bottoms of the pattern units are closer than the tops of the pattern units to the PDP.

9. A plasma display device, comprising:
a plasma display panel(PDP); and
an external light shielding sheet, which is disposed at a front of the PDP and includes a base unit and a plurality of pattern units which are formed on the base unit and absorb external light, wherein the external light shielding sheet includes a first pattern unit and a second pattern unit which are adjacently formed in parallel; and a third pattern unit which is formed in crosswise manner with the first and second pattern units and connects the first and second pattern units to each other.

10. The plasma display device of claim 9, wherein an angle between the first pattern unit and the third pattern unit is 45 to 135 degrees.

11. The plasma display device of claim 9, wherein a width of the third pattern unit is 0.1 to 5 times greater than a width of the first pattern unit.

12. The plasma display device of claim 9, wherein the width of the third pattern unit is less than the width of the first pattern unit.

13. The plasma display device of claim 9, a width of the third pattern unit is 0.3 to 0.6 times greater than a width of the first pattern unit.

14. The plasma display device of claim 9, wherein a width of the third pattern unit is 5.4 μm to 35 μm.

15. The plasma display device of claim 9, wherein the external light shielding sheet further comprises a fourth pattern unit which is formed adjacently to the third pattern unit and connects the first and second pattern units, and wherein a distance between the first and second pattern units is less than a distance between the third and fourth pattern units.

16. The plasma display device of claim 15, wherein the distance between the first and second pattern units is 0.05 to 0.5 times greater than the distance between the third and fourth pattern units.

17. The plasma display device of claim 15, wherein the distance between the third and fourth pattern units is 80 μm to 1800 μm.

18. The plasma display device of claim 9, wherein the external light shielding sheet further comprises a fourth pattern unit which is formed adjacently to the third pattern unit and connects the first and second pattern units; and
a fifth pattern unit and a sixth pattern unit which are formed in crosswise manner with the first and second pattern units and connect the first and second pattern units to each other, and wherein a distance between the third and fourth pattern units is different from a distance between the fifth and sixth pattern units.

19. The external light shielding sheet of claim 9, wherein a refractive index of the pattern units is higher than a refractive index of the base unit, and a difference between a refractive index of the pattern units and a refractive index of the base unit is 0.05 to 0.3.

20. The plasma display device of claim 9, wherein a refractive index of the pattern units is 1.0 to 1.3 times greater than a refractive index of the base unit.

21. The plasma display device of claim 9, wherein bottoms of the pattern units are wider than tops of the pattern units and the bottoms of the pattern units are closer than the tops of the pattern units to the PDP.

22. A plasma display device, comprising:
a plasma display panel(PDP); and
an external light shielding sheet, which is disposed at a front of the PDP and includes a base unit and a plurality of pattern units which are formed on the base unit and absorb external light, wherein the front shape of the plurality of pattern units has at least one closed curve.

23. The plasma display device of claim 22, wherein the front shape of the plurality of pattern units has at least one polygon or circle.

24. An external light shielding sheet, comprising:
a base unit; and
a plurality of pattern units which are formed on the base unit and absorb external light, wherein at least one of the pattern units has an ascending portion with an average slope of 0.5 to 45 degrees and a descending portion with an average slope of −45 to −0.5 degrees.

25. An external light shielding sheet, comprising:
a base unit; and
a plurality of pattern units which are formed on the base unit and absorb external light, wherein the plurality of pattern units include a first pattern unit and second pattern unit which are adjacently formed in parallel; and a third pattern unit which is formed in crosswise manner with the first and second pattern units and connects the first and second pattern units to each other.

26. The plasma display device of claim 23, wherein an angle between the first pattern unit and the third pattern unit is 45 to 90 degrees.

27. An external light shielding sheet, comprising:
a base unit; and
a plurality of pattern units which are formed on the base unit and absorb external light, wherein the front shape of the plurality of pattern units has at least one closed curve.
